(19) United States
(12) Patent Application Publication
(10) Pub. No.: US 2023/0351731 A1
(43) Pub. Date: Nov. 2, 2023

(54) FEATURE DETECTION BASED ON TRAINING WITH REPURPOSED IMAGES

(71) Applicant: KONINKLIJKE PHILIPS N.V., EINDHOVEN (NL)

(72) Inventors: Joël Valentin STADELMANN, MOSCOW (RU); Heinrich SCHULZ, HAMBURG (DE); Steffen RENISCH, HAMBURG (DE)

(21) Appl. No.: 18/014,810

(22) PCT Filed: Jul. 5, 2021
(86) PCT No.: PCT/EP2021/068445

§ 371 Date: Jan. 6, 2023

(30) Foreign Application Priority Data
Jul. 10, 2020 (RU) 2020123043

(51) Int. Cl. G06V 10/774; G06T 7/00

(52) U.S. Cl. CPC G06V 10/774; G06T 7/0012; G06V 2201/03; G06T 2207/20092; G06T 2207/20081

(57) ABSTRACT

A system, a method and/or a computer-readable storage medium are configured to detect a feature of a rare disease that visually manifests in images generated by an imaging modality at a health care entity based on training with repurposed images of the health care entity. A repurposed image includes values of pixels of an image generated by the imaging modality that does not include the feature and values of pixels of a synthetic feature in a feature image that visually mimics the feature. The feature image is created based on a model and user input. A set of repurposed images are used to train an artificial intelligence algorithm to detect the feature in images. Optionally, the trained artificial intelligence algorithm can be validated with images generated by the imaging modality that include the feature. The trained artificial intelligence algorithm used to detect the feature in an image of a subject.

### FIELD

The following generally relates to image processing and more particularly to feature detection based on training with repurposed images.

### BACKGROUND

The field of computer vision includes configuring a computer to perform tasks similar to the human visual system. An example of such a task is feature detection in an image. For example, in the field of medical imaging, images of the inside of a body are acquired for diseases that manifest as visual features in the images. Clinicians such as radiologists are trained to visually inspect images for a presence/absence of the visual features. The inspection can be to rule out a disease, diagnose a disease, monitor a progression of a disease, etc.

Computer implemented algorithms have been used to assist clinicians with such tasks. An example of such an algorithm is a deep learning artificial intelligence (AI) algorithm. However, deep learning algorithms, such as a deep neural network, etc., require large training image datasets in order to produce accurate and reliable results for diagnostic purposes. Unfortunately, a healthcare entity generally does not have a large number of images for a rare disease since the disease is rare and so there are not many cases of the disease available for imaging.

In the United States, the Rare Diseases Act of 2002 (42 U.S.C. 287a-1) defines a rare disease as “any disease or condition that affects less than 200,000 persons in the United States.” Generally, a rare disease as utilized herein is a disease that affects only a small percentage of the population so that the number of cases available for imaging is such that a large dataset of images for the disease is not available for training artificial intelligence to detect the feature(s) manifested in images due to a presence of the rare disease for diagnostic purposes. As an example, for a healthcare organization, where the number of images for a disease is low or if the images do not represent a full diversity of the disease, the disease is considered too rare to aggregate images to build a database sufficient for training an AI algorithm to detect a presence of the rare disease for diagnostic purposes.

A larger image dataset may be created for the rare disease by including images of the rare disease from other healthcare entities. However, each healthcare entity has its own set of imaging protocols and image acquisition parameters, which results in dissimilar visual characteristics, such as contrast, resolution, noise, etc., from healthcare entity to healthcare entity. Unfortunately, training with such images tends to lead to different performance at each healthcare entity and less accurate and reliable results, relative to training with images acquired with similar acquisition parameters.

In view of at least the above, there is an unresolved need for another approach(s) for a system for detecting a presence/absence of a rare disease.

### SUMMARY

Aspects described herein address the above-referenced problems and/or others.

The following describes a computer implemented approach for detecting a feature of a rare disease in an image at a health care entity based on training with repurposed images of the health care entity, where the rare disease visually manifests in the image as the feature, and a repurposed images includes an image that initially did not include the feature but has been adapted to include a synthetic feature that mimics the feature. This approach is well-suited for a health care entity that requires more training images for the rare disease to produce results that can assist clinicians with diagnoses of the rare disease.

For example, images at the health care entity that are unrelated to the rare disease and that were acquired based on the same acquisition parameters can be adapted to include the synthetic feature to create repurposed images, a large training image dataset can then be created therefrom for the rare disease and used to train a computing system to detect the feature in images of subjects, and, once trained, the computing system can be used to detect the feature in an image(s) of a subject if present in the image. As such, the approach described herein mitigates poor performance due to lack of training images and/or images with dissimilar visual characteristics.

In one aspect, a system is configured to detect a visual feature manifested by a rare disease in an image of a subject generated by an imaging modality of a healthcare entity. The system includes a data repository(s) configured to store images generated by the imaging modality, wherein the images include at least one image that does not include the visual feature. The system further includes a computing apparatus configured to execute instructions of a training data creation module to create training data based on the at least one image, instructions of an artificial intelligence training module to train an artificial intelligence module based on the training data, and instructions of the artificial intelligence module to detect the visual feature in the image of the subject based on the training data.

In another aspect, a method is configured to detect a visual feature manifested by a rare disease in an image of a subject generated by an imaging modality of a healthcare entity. The method includes obtaining at least one image that does not include the visual feature from a data repository of the healthcare entity, creating training data based on the at least one image, training an artificial intelligence module based on the training data, and detecting the visual feature in the image of the subject based on the training data.

In another aspect, a computer-readable storage medium stores instructions for detecting a visual feature manifested by a rare disease in an image of a subject generated by an imaging modality of a healthcare entity. The instructions, when executed by a processor of a computer, cause the processor to obtain at least one image that does not include the visual feature from a data repository of the healthcare entity, create training data based on the at least one image, train an artificial intelligence module based on the training data, and detect the visual feature in the image of the subject based on the training data.

Those skilled in the art will recognize still other aspects of the present application upon reading and understanding the attached description.

### BRIEF DESCRIPTION OF THE DRAWINGS

The invention may take form in various components and arrangements of components, and in various steps and arrangements of steps. The drawings are only for purposes of illustrating the embodiments and are not to be construed as limiting the invention.

FIG. 1 diagrammatically illustrates an example system configured to detect a feature in an image of a subject based on repurposed images, in accordance with an embodiment(s) herein.

FIG. 2 diagrammatically illustrates an example of the training data creation module of the system of FIG. 1, in accordance with an embodiment(s) herein.

FIG. 3 diagrammatically illustrates example training of the AI module of the system of FIG. 1 with the AI training module of the system of FIG. 1, in accordance with an embodiment(s) herein.

FIG. 4 illustrates an example method for detecting a feature in an image of a subject based on repurposed images, in accordance with an embodiment(s) herein.

### DESCRIPTION OF EMBODIMENTS

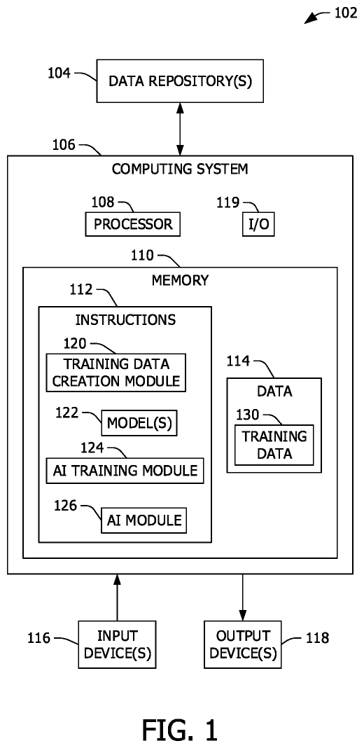

FIG. 1 diagrammatically illustrates an example system 102. In this embodiment, the system 102 includes a data repository(s) 104 and a computing system 106.

The data repository(s) 104 includes a storage medium configured to store at least digital images. In one instance, the data repository(s) 104 is for a healthcare entity and includes images of subjects acquired by imaging modalities of the healthcare entity. Examples of modalities include magnetic resonance (MR), computed tomography (CT), single photon emission tomography (SPECT), positron emission tomography (PET), X-ray, etc.

A rare disease of interest manifests as a visual feature in one or more images of at least one of these imaging modalities. In the framework of this invention, a rare disease can be defined as follows: a healthcare organization implements a state-of-the-art AI algorithm using the images available in its data storage system. If the number of those images is low or if the images do not represent the full diversity of the disease, the performances of the AI algorithm will be lower than the published results. At this point the disease is too rare to aggregate s sufficient database for training.

For the at least one of the above noted imaging modalities, the data repository(s) 104 includes one or more images that do not include the visual feature. Generally, these images are unrelated to the rare disease. In one instance, the data repository(s) 104 additionally includes at least one image that includes the visual feature.

The illustrated computing system 106 includes a processor 108 (e.g., a central processing unit (CPU), a microprocessor (CPU), and/or other processor) and computer readable storage medium (“memory”) 110 (which excludes transitory medium), such as a physical storage device like a hard disk drive, a solid-state drive, an optical disk, and/or the like. The memory 110 includes at least computer executable instructions 112 and data 114. The processor 108 is configured to execute the computer executable instructions 112.

An input device(s) 116, such as a keyboard, mouse, a touchscreen, etc., is in electrical communication with the computing system 106. A human readable output device(s) 118, such as a display, is also in electrical communication with the computing apparatus 106. Input/output (“I/O”) 119 is configured for communication (wire and/or wireless) between the computing system 106 and the data repository(s) 104, including retrieving/receiving data from and/or conveying data to the data repository(s) 104.

The instructions 112 includes instructions at least for a training data creation module 120, a model(s) 122, an AI training module 124 and an AI module 126. The data 114 includes at least training data 130. As described in greater detail below, in one embodiment, the training data creation module 120 employs a model of the model(s) 122 to create the training data 130, the AI training module 124 utilizes the training data 130 to train an AI algorithm(s) of the AI module 126 to detect the visual feature of the rare disease of interest, and the AI module 126, after training, is configured to detect the visual feature of the rare disease of interest in an image of a subject when present in the image.

By creating the training data 130 as discussed herein the AI module 126 can be trained to provide results that can be used to assist diagnosing the disease, even when the disease affects only a small percentage of the population so that the number of cases available for imaging is such that a large dataset of images for the disease is not available for training artificial intelligence to detect the feature(s) manifested in images due to a presence of the rare disease for diagnostic purposes. Again, this approach well-suited for a healthcare entity that requires more training images of the rare disease to produce results that can assist clinicians with diagnosing the rare disease based at least on such images.

As briefly discussed above, the training data creation module 120 employs a model of the model(s) 122 to create the training data 130. More particularly, the model employed is a model that creates a synthetic feature that mimics the feature visually manifested in an image by the rare disease of interest. In one instance, the model is an explicit mathematical model. By way of non-limiting example, for a multiple sclerosis (MS) lesion, a suitable model is a two-dimensional (2-D) Butterworth model configured to generate a synthetic MS lesion image to combine with an image from a Fluid-attenuated inversion recovery (FLAIR) MRI brain scan, which is a sequence with an inversion recovery set to null fluids to suppress cerebrospinal fluid (CSF) effects to visually emphasize lesions such as MS lesions.

An example of a suitable Butterworth model for generating the synthetic MS lesion feature image I_{feature} is shown in EQUATION 1:

$${I}_{feature} ( x , y ) = \frac{1}{( 1 + {( \frac{{( x - {c}_{x} )}^{2} + {( y - {c}_{y} )}^{2}}{{c}^{2}} )}^{o} )} , \qquad EQUATION 1$$

where x and y represents coordinates of a pixel on an image, cₓc_{y} represent a center of the synthetic lesion, c represents a spatial cutoff frequency, and o represents an order of the filter. The model parameters are tuned by a human so that the synthetic feature visual resembles the feature of interest. For example, c controls a size of the synthetic lesion and o controls a sharpness of the roll-off of the filter so c is tuned so that a size of the synthetic lesion resembles a size of a MS lesion and o is tuned so that the boundary of the synthetic lesion resembles the sharp boundary a MS lesion.

By way of further non-limiting example, for a pleural effusion, a suitable model is a Gaussian model since its appearance on images resembles that of a pleural effusion. An example suitable Gaussian model for generating the synthetic pleural effusion feature image I_{feature} is shown in EQUATION 2:

$${I}_{feature} ( x , y ) = \frac{1}{2 π {σ}^{2}} {e}^{( - \frac{{( x - {c}_{x} )}^{2} + {( y - {c}_{y} )}^{2}}{2 {σ}^{2}} )} , \qquad EQUATION 2$$

which describes a round lesion centered around (cₓ; c_{y}) with smooth boundaries, which are controlled by σ. With another non-limiting example, e.g., to insert the wires of support devices on X-rays, a suitable model is a Spline-based model. An example suitable Spline-based model for generating the feature image I_{feature} is shown in EQUATION 3:

$$EQUATION 3$$

$${I}_{feature} ( x , y ) = [ \begin{matrix}y = {a}_{3} {x}^{3} + {a}_{2} {x}^{2} + {a}_{1} x + {a}_{0} ∀ x ∈ [ {x}_{1} ; {x}_{2} ] \\ y = {b}_{3} {x}^{3} + {b}_{2} {x}^{2} + {b}_{1} x + {b}_{0} ∀ x ∈ [ {x}_{2} ; {x}_{3} ]\end{matrix} ,$$

which describes a lesion in the shape of a curved line going through three points (x₁; y₁), (x₂; y₂), and (x₃; y₃), where the parameters aᵢ and bᵢ describe the curvature of the line.

More generally, the model and the parameters of the model for a particular feature of interest that visually manifests in an image due to the rare disease of interest are selected to create a synthetic feature that mimics the visual feature of interest. In this respect, the knowledge of a human is incorporated into the creation of the of the synthetic feature. The visual appearance of the feature of interest in an image can be determined based on medical literature, a clinician's experience with the rare disease, and/or otherwise.

In one instance, for the feature image, pixel values of pixels outside of pixels corresponding to a synthetic feature are given a value of zero so that they represent, e.g., air or empty space. In another instance, the computing system 106 knows which pixels of the feature image correspond to the synthetic feature and which do not. In yet another instance, the feature image includes only the synthetic feature. In yet another instance, the synthetic feature is located in the feature image based on the anatomy in an image to be repurposed so that the location of the synthetic feature in the feature image corresponds to a location in the image where the feature could manifest.

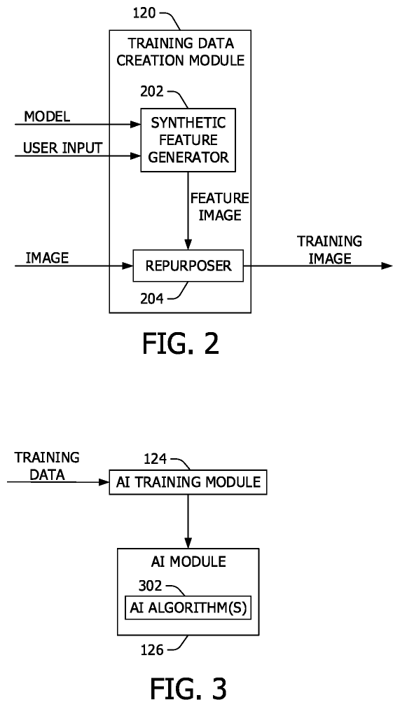

FIG. 2 illustrates an example of the training data creation module 120. The illustrated training data creation module 120 includes a synthetic feature generator 202 and a repurposer 204.

The synthetic feature generator 202 retrieves and/or receives a copy of at least one image without the feature from the data repository(s) 104. In one instance, the training data creation module 120 creates the training data 130 based on a single image without the feature. With a single image, the training data 130 will have similar visual characteristics (e.g., contrast, resolution, noise, etc.). In another instance, the training data creation module 120 creates the training data 130 based on multiple images without the feature. Generally, the images utilized are images acquired with the same or similar acquisition parameters to minimize any differences in the visual characteristics.

The repurposer 204 creates a training image by creating an image where each pixel value is a summation of a value of a corresponding pixel of the retrieved and/or received image and a value of a corresponding pixel of the synthetic feature image. In this embodiment, the synthetic feature generator 202 creates the feature image “on-the-fly” as the repurposer 204 repurposes the image. In another instance, one or more features images are created and stored and then used to repurpose the retrieved and/or received image. The training data 130, after training, can be stored locally in the data 114, the data repository(s) 104 and/or by other storage medium, or discarded.

As example of a suitable algorithm for repurposing an image for training (i.e., creating a training image) is shown in EQUATION 4:

Iᵣₑₚᵤᵣₚₒₛₑ=Iₙₒₙ₋ᵣₐᵣₑ+I_{feature}, EQUATION 4:

where Iᵣₑₚᵤᵣₚₒₛₑ represents an image with the synthetic feature, Iₙₒₙ₋ᵣₐᵣₑ represents an image from the data repository(s) 104 that does not include the feature, and I_{feature} represents the feature image, as discussed in greater detail above. EQUATION 4 is constrained so that the synthetic feature is added to anatomy where the feature manifests.

For instance, in EQUATION 1 cₓc_{y} can be determined by a human, a random number generator and/or otherwise, and MS lesions appear as white zones in the white matter on MRI FLAIR images. As such, EQUATION 4 is constrained so that the synthetic MS lesion is added only to the white matter. The white matter can be identified through known and/or other automatic, semi-automatic or manual segmentation approaches. A repurposed image can include one or more synthetic features. In this instance, a size and/or shape of two or more of the synthetic features can be different, within size and/or shape constraints of a feature.

The repurposed image is incorporated into the training data 130. Generally, this image can be considered as the input image, which did not include the feature and could not be used for training to detect the feature, repurposed so that it can be used for training to detect the feature. In one instance, one or more additional training images are similarly created. Alternatively, or additionally, one or more additional training images are created by visually manipulating the repurposed image, e.g., through mirroring, translation, spatial frequency enhancement, etc. The training data creation module 122 creates a large set of the training data 130.

FIG. 3 diagrammatically illustrates example training of the AI module 126 with the AI training module 124. The AI training module 124 utilizes the large set of the training data 130 for training an AI algorithm(s) 302 of the AI module 126 to detect the feature in images acquired for the rare disease of interest by the imaging modality of the healthcare entity. Examples of a suitable AI algorithm(s) 302 include a deep learning architectures such as deep neural networks, deep belief networks, recurrent neural networks, convolutional neural networks, etc., as well as other algorithms such as a Support Vector Machine (SVM), a random forest, a Bayesian network, evolutionary algorithms, and/or other AI algorithm(s). Once trained, the AI module 126 is configured to detect the feature in images acquired for the rare disease of interest by the imaging modality of the healthcare entity.

Variations are discussed next.

In a variation, the model of the model(s) 122 utilized to create the synthetic feature is a generative model such as a variational autoencoder (VAE), a generative adversarial network (GAN), a flow-based generative models, and/or other model, instead of an explicit mathematical model.

In a variation, the training data 130 additionally includes images from the data repository(s) 104 acquired for the rare disease and that include the feature of interest.

In a variation, the training data 130 additionally includes images from the data repository(s) 104 that do not include the feature of interest. Such images can be utilized to train the AI module 126 to detect images that do not include the feature of interest.

In a variation, the AI module 126 is retrained with newly created training data where at least one model parameter is changed for at least one synthetic feature.

In a variation, the AI module 126 is retrained with training data that includes the previously used training data supplemented with additional newly created training data.

In a variation, the training is updated by providing images that were correctly identified by the AI module 126 as including the feature as input to the AI training module 126.

In a variation, images from the data repository(s) 104 with the feature for the rare disease are provided as input to the AI module 126. In this embodiment, the training can be validated, e.g., where a percentage of successful detections of the feature by the AI module 126 satisfies a predetermined percentage of successful detections. The percentage can be displayed via a display of the output device(s) 118. Alternatively, or additionally, a number of successful detections along with a number unsuccessful detections and/or a total number of images processed can be displayed via the display.

In a variation, the training data creation module 120 creates a training image by directly adding pixel values of a synthetic feature in a feature image to pixel values of the images from the data repository(s) 104 at pixel locations where an actual feature can manifest.

In a variation, the training data creation module 120 creates a training image with one or more images additionally from data repository(s) 104 from one or more other health care entities where the one or more other health care entities utilize the same imaging parameters as the health care entity and/or the one or more images can be processed to create images as if the same imaging parameters were used.

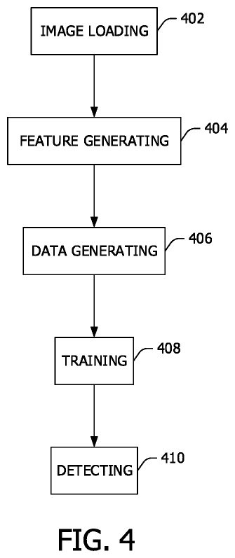

FIG. 4 illustrates an example method in accordance with an embodiment(s) herein. It is to be appreciated that the ordering of the acts of one or more of the method is not limiting. As such, other orderings are contemplated herein. In addition, one or more acts may be omitted, and/or one or more additional acts may be included.

An image loading step 402 loads one or more images from at least the data repository(s) 104 that does not include the feature of interest for the rare disease of interest, as described herein and/or otherwise.

A feature generating step 404 generates one or more feature images with one or more synthetic features representing the feature of interest, as described herein and/or otherwise.

A data generating step 406 generates a large set of training images based on the loaded one or more images and the one or more feature images, as described herein and/or otherwise.

A training step 408 trains the AI module 126 with the training images, as described herein and/or otherwise.

A detecting step 410 detects, with the trained AI module 126, the feature in an image of a subject under evaluation, as described herein and/or otherwise.

The above methods can be implemented by way of computer readable instructions, encoded, or embedded on the computer readable storage medium 110, which, when executed by a computer processor(s), cause the processor(s) 108 to carry out the described acts. Additionally, or alternatively, at least one of the computer readable instructions is carried out by a signal, carrier wave or other transitory medium, which is not computer readable storage medium.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

The word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage.

A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A system configured to detect a visual feature manifested by a rare disease in an image of a subject generated by an imaging modality of a healthcare entity, comprising:
a data repository(s) configured to store images generated by the imaging modality, wherein the images include at least one image that does not include the visual feature; and
a computing apparatus configured to execute:
instructions of a training data creation module to create training data based on the at least one image;
instructions of an artificial intelligence training module to train an artificial intelligence module based on the training data; and
instructions of the artificial intelligence module to detect the visual feature in the image of the subject based on the training data.

2. The system of claim 1, wherein the training data creation module repurposes the at least one image to include a synthetic feature that visually mimics the feature based on a model(s) 122 to create the training data.

3. The system of claim 2, wherein the training data creation module generates a feature image with the synthetic feature based on a mathematical model.

4. The system of claim 3, wherein the mathematical model includes at least one user adjustable parameter.

5. The system of claim 4, wherein the training data creation module sets the at least one adjustable parameter based on human input.

6. The system of claim 3, wherein the training data creates a training image by summing pixels values of the at least one image and pixels values of the synthetic feature in the feature image.

7. The system of claim 2, wherein the training data creation module repurposes at least one additional image that does not include the feature to include the synthetic feature that mimics the feature.

8. The system of claim 2, wherein the training data creation module creates at least one additional repurposed image by visually manipulating the synthetic feature.

9. The system of claim 1, where the artificial intelligence training module validates the artificial intelligence module based on at least one image from the data repository(s) that include the visual feature.

10. The system of claim 1, where the artificial intelligence module includes a deep learning artificial intelligence algorithm.

11. A computer-implemented method for detecting a visual feature manifested by a rare disease in an image of a subject generated by an imaging modality of a healthcare entity, comprising:
obtaining at least one image that does not include the visual feature from a data repository of the healthcare entity;
creating training data based on the at least one image;
training an artificial intelligence module based on the training data; and
detecting the visual feature in the image of the subject based on the training data.

12. The computer-implemented method of claim 11, further comprising:
repurposing the at least one image to include a synthetic feature that mimics the feature based on a model(s) to create the training data.

13. The computer-implemented method of claim 12, further comprising:
generating the synthetic feature based on a mathematical model, wherein the mathematical model includes at least one user adjustable parameter; and
creating a training image by summing pixels values of the at least one image and pixels values of the synthetic feature in a feature image.

14. The computer-implemented method of claim 12, further comprising:
repurposing at least one additional image to include the synthetic feature to create the training data.

15. The computer-implemented method of claim 12, further comprising:
creating at least one additional repurposed image by visually manipulating the synthetic feature.

16. A computer-readable storage medium storing computer executable instructions, for detecting a visual feature manifested by a rare disease in an image of a subject generated by an imaging modality of a healthcare entity, which when executed by a processor of a computer cause the processor to:
obtain at least one image that does not include the visual feature from a data repository of the healthcare entity;
create training data based on the at least one image;
train an artificial intelligence module based on the training data; and
detect the visual feature in the image of the subject based on the training data.

17. The computer-readable storage medium of claim 16, wherein the computer executable instructions further cause the processor to:
repurpose the at least one image to include a synthetic feature that mimics the feature based on a model(s) to create the training data.

18. The computer-readable storage medium of claim 17, wherein the computer executable instructions further cause the processor to:
generate the synthetic feature based on a mathematical model, wherein the mathematical model includes at least one user adjustable parameter; and
create a training image by summing pixels values of the at least one image and pixels values of the synthetic feature in a feature image.

19. The computer-readable storage medium of claim 17, wherein the computer executable instructions further cause the processor to:
repurpose at least one additional image to include the synthetic feature to create the training data.

20. The computer-readable storage medium of claim 17, wherein the computer executable instructions further cause the processor to:
create at least one additional repurposed image by visually manipulating the synthetic feature.
